(19) United States
(12) Patent Application Publication
(10) Pub. No.: US 2010/0288834 A1
(43) Pub. Date: Nov. 18, 2010

(54) Systems And Methods For Controlling Payment And Information Flows In Payment-By Card Networks

(76) Inventors: Mikael Tichelaer, Leuven (BE); Jorn Lambert, Waterloo (BE); Erik Cauwenberg, Kortenberg (BE)

Correspondence Address: BAKER BOTTS L.L.P., 30 ROCKEFELLER PLAZA, 44TH FLOOR, NEW YORK, NY, 10112-4498, US

(21) Appl. No.: 12/530,418

(22) PCT Filed: Mar. 5, 2008
(86) PCT No.: PCT/US08/55890

§ 371 Date: Aug. 3, 2010

Related U.S. Application Data
(60) Provisional application No. 60/893,071, filed on Mar. 5, 2007.

(51) Int. Cl. G06Q 20/00

(52) U.S. Cl. 235/380

(57) ABSTRACT

A system and method for processing payment transactions made in the commerce using diverse payment device types. A centralized transaction processing platform is integrated with a standard payment-by-card industry network to process transactions made using different payment device types in the same manner as a conventional credit or debit card transaction. A single platform can provide a range of secure, flexible physical and virtual world payment solutions for all devices types including physical and virtual cards, RFID, mobile, etc.

### CROSS-REFERENCE TO RELATED APPLICATIONS

This application claims the benefit of U.S. Provisional Patent Application Ser. No. 60/893,071, filed on Mar. 5, 2007, entitled “Systems and Methods for Controlling Payment and Information Flows in Payment-By-Card Networks,” which is hereby incorporated by reference in its entirety herein.

### BACKGROUND OF THE INVENTION

The disclosed subject matter relates to transaction processing in the payment-by-card industry.

The use of payment devices that are linked to customer accounts (e.g., credit cards, debit cards, charge cards, smart cards, etc.) is commonplace for conducting financial transactions in the modern economy. The payment-by-card industry involves many different entities (e.g., card issuers, merchant acquirers, payment processors, etc.) that perform various tasks for processing payment-by-card transactions (i.e., handling the information and payment flows needed for converting an electronic record created at the point of sale into cash for the merchant). FIG. 1 shows an exemplary four-party network involved in processing payment-by-card transactions including transaction authorization, and clearing and settlement.

Payment transaction and information management messages may use the Integrated Product Message (IPM) format, which is a feature-rich, flexible, variable-length format that supports new technologies such as chip cards, e-commerce and member-to-member proprietary data.

The payment devices that are in use in the payment-by-card-industry are diverse. Card issuers may offer private-label payment cards directly to individuals and businesses. Alternatively, card issuers may offer cobranded cards issued in partnership with major credit providers (e.g., MasterCard). Further, the different entities involved in the payment-by-card industry often differentiate their products and services in the marketplace by associating or linking their payment cards or services with additional features to be competitive in the marketplace. For example, banks or other issuers may link rewards programs to the use of their particular payment cards. Similarly, merchants may link use of payment cards with coalition or loyalty programs that help build the relationship between consumer and merchant. Issuers may offer single-use or limited use cards to prevent fraudulent use. Similarly, issuers may offer multiple cards linked to a single payment account, for example, for the convenience of a businesses and a family. The payment devices can be used at points of sale, by mail, and over the telephone or the Internet. Several issuers now provide their customers the opportunity to manage their accounts online (e.g., online bill pay). Further, the issuers may provide customers with virtual or proxy payment cards for online commerce.

Corresponding to the diversity of payment device types and features, and their use, payment-by-card transaction processing requirements can be diverse and fragmented. Different transaction processing modules and service providers may be required to process different aspects of a single payment transaction related to the different features of the payment device or its use.

Consideration is now being given to ways of enhancing a global payment card processing system to allow common or centralized transaction processing of different aspects of payment transactions corresponding to diverse payment device types, features, and their use.

### SUMMARY OF THE INVENTION

A system and method are provided for processing transactions that are made using diverse payment device types in the commerce. A centralized transaction processing platform is integrated with a standard payment-by-card industry network to process transactions made using different payment device types in the same manner as a conventional credit or debit card. A single platform can provide a range of secure, flexible physical and virtual world payment solutions for all devices (cards, RFID, mobile, etc.).

The system and method involve processing payment transactions made using unconventional and diverse payment devices as if they were made using conventional “plastic” magnetic stripe or smart payment cards (e.g. MasterCard, Visa, and American Express cards). A centralized transaction processing platform is connected to standard payment-by-card industry networks (e.g. MasterCard's CGMS and EPSnet networks) that process transactions made with conventional payment cards. The centralized transaction processing platform interrogates payment transactions with respect to pre-defined rules-based transaction controls transaction controls. The platform, accordingly, denies transaction authorization requests or forwards the same for further processing to other entities on the network. This arrangement allows application of the rules-based transaction controls before a purchase is made.

Further, the centralized transaction processing platform can route individual transactions to according to pre-determined routing rules for the funding of the payment transactions. Diversionary billing schemes in which cardholder transactions are charged to different payment accounts, for example, according to transaction type, can be implemented.

The centralized transaction processing platform is generates a controlled payment number (CPN) for each transactions. The CPN serves as a proxy for the cardholder's real card or account number in transaction processing. The CPN can be provided to a cardholder upon request (e.g., through a web interface) for use in Card Not Present transactions as a proxy for the cardholder's real card or account number.

The CPN number generated by the centralized transaction processing platform is used as an index for tracking a transaction on the payment network and with network entities through authorization, clearing and settlement. The centralized transaction processing platform can be linked to an issuer via a P2P link in the payment network's infrastructure, and can communicate CPN-indexed transaction settlement and chargeback flows directly with the issuer over the P2P link.

### BRIEF DESCRIPTION OF THE DRAWINGS

Further features and advantages of the disclosed subject matter will become apparent from the following detailed description taken in conjunction with the accompanying figures showing illustrative embodiments of the disclosed subject matter, in which:

FIG. 1 is schematic illustration of a standard four party network for processing payment card transactions.

FIG. 2 is a schematic illustration of a hosted payment solution or transaction platform, which is integrated with the standard four-party payment-by-card network. The hosted payment solution provides centralized transaction processing services for diverse payment device types and transaction processing needs, in accordance with the principles of the present invention.

FIG. 3A is a schematic diagram illustrating the processing features of an exemplary transaction processing platform, in accordance with the principles of the present invention.

FIG. 3B is a schematic diagram illustrating the common platform services, vertical integration of multiple applications, and different access channels provided by an exemplary transaction processing platform, in accordance with the principles of the present invention.

FIG. 4 is a schematic illustration of a diversionary billing scheme provided by a centralized transaction platform for a combined parent-child account, in accordance with the principles of the present invention.

FIGS. 5A-C are screen shots of exemplary web interfaces for creating rules-based authorization controls on transactions made by cardholders, in accordance with the principles of the present invention.

FIG. 6 is a schematic illustration of a control scheme provided by a centralized transaction platform for employee business card use, in accordance with the principles of the present invention.

FIG. 7 is a schematic illustration of transaction processing functions provided by a centralized transaction platform for transaction payments made via an e-payment service (e.g., PayPal), in accordance with the principles of the present invention.

FIG. 8 is a schematic illustration of transaction processing functions provided by a centralized transaction platform for purchase card (P-Card) transactions, in accordance with the principles of the present invention.

FIGS. 9A and 9B are schematic illustrations of conventional transaction processing functions and transaction processing functions provided by a centralized transaction platform, respectively, for brokered services (e.g., travel management services), in accordance with the principles of the present invention.

FIG. 10A shows exemplary set up and authorization request flows mediated by a centralized transaction platform, in accordance with the principles of the present invention.

FIG. 10B shows authorization response flows mediated by a centralized transaction platform, in accordance with the principles of the present invention.

FIG. 11A shows exemplary clearing presentment flows mediated by a centralized transaction platform, in accordance with the principles of the present invention.

FIG. 11B shows exemplary clearing exception cycle flows mediated by a centralized transaction platform, in accordance with the principles of the present invention.

FIG. 12 shows exemplary GDR/SDOL flows mediated by a centralized transaction platform, in accordance with the principles of the present invention.

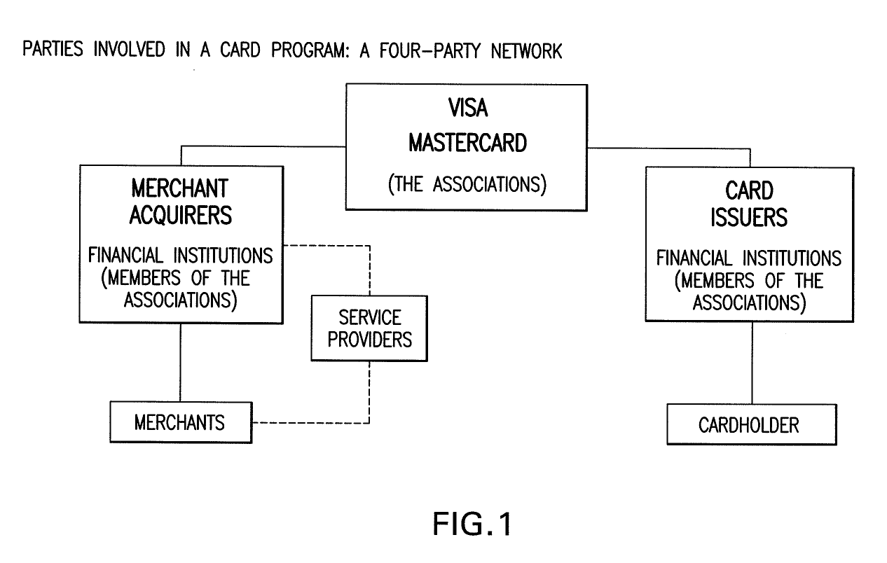

Throughout the figures, the same reference numerals and characters are used to denote like features, elements, components or portions of the illustrated embodiments, unless otherwise stated.

### DETAILED DESCRIPTION

A centralized transaction processing platform and method are provided for processing transactions that are made using diverse payment device types. The transaction processing platform may be used to provide hosted services to payment-by-card network entities (e.g., merchants, acquirers, service providers, processors, issuers, etc.). A single platform can provide a range of secure, flexible physical and virtual world payment solutions for all devices (cards, RFID, mobile, etc.).

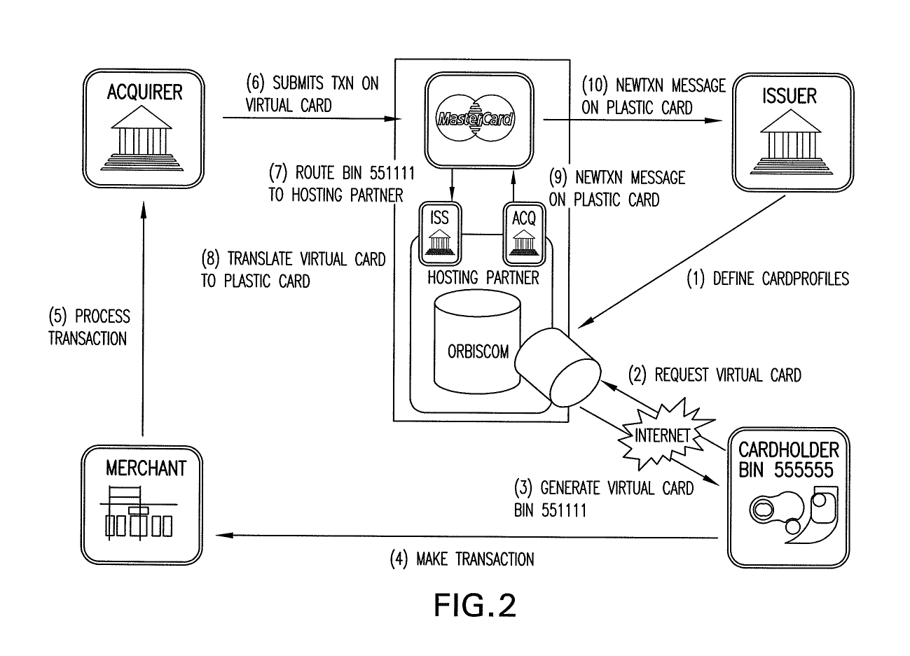

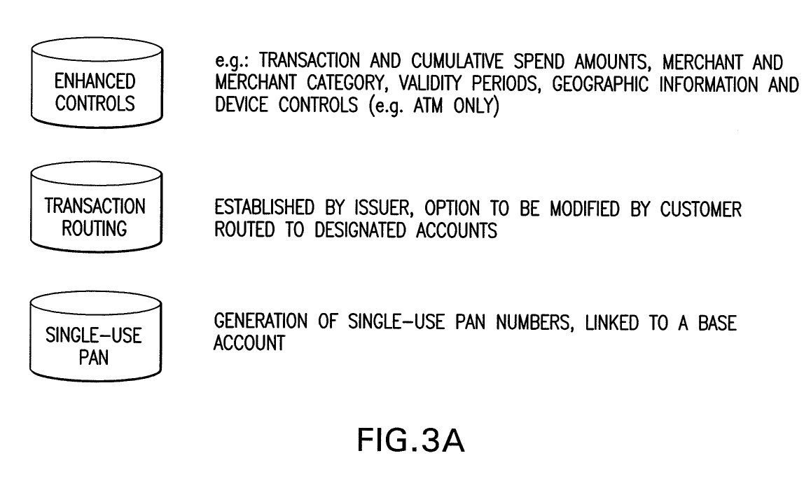

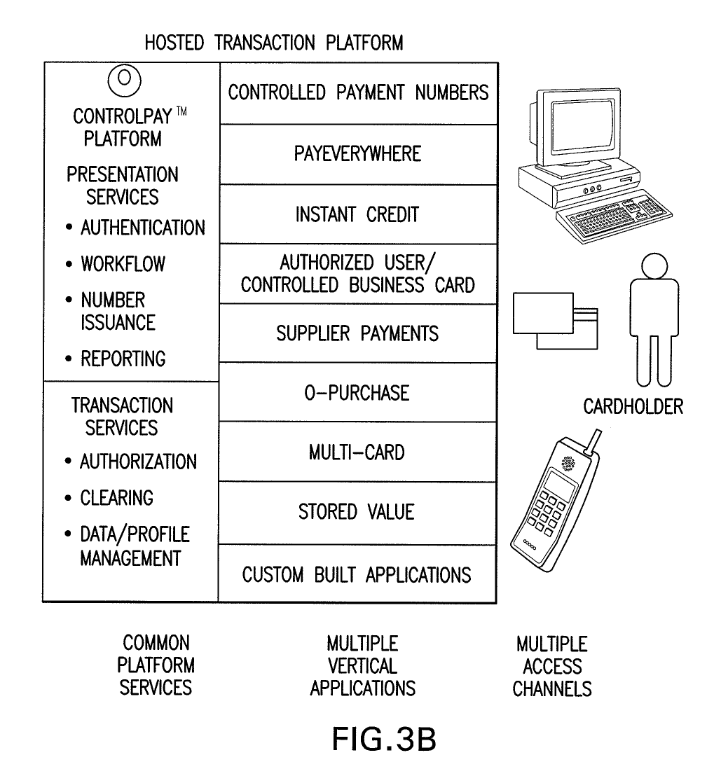

The centralized transaction processing platform can be seamlessly integrated with existing payment-by-card networks, including custom electronic payment networks (e.g., TSYS) that are presently used by merchants 240, acquirers 250 and card issuers 260 (e.g., banks) for transaction processing services. FIG. 2 shows a payment network in which a centralized transaction processing platform 210 (FIG. 3B) is linked to an exemplary payment-by-card network 200 by a hosting partner 220. Platform 210 provides transaction processing to issuers via centralized location 270 (e.g., at the card association, MasterCard). The transaction processing product suites provided in platform 210 may be customized to address specific merchant, acquirer or card issuer needs or requirements. Platform 210 supports a web interface 280, which can be interactively accessed by cardholders or other entities.

The centralization and customization of transaction processing can advantageously lessen the transaction processing burden on merchants, acquirers, or card issuers, and may reduce costs of customized card products, programs or solutions by providing economies of scale.

An exemplary platform 210 is the “ControlPay™ Platform” provided by Orbiscom Inc., The Chanin Building, 122 East 42nd Street, Suite 2005, New York, N.Y. 10168. The ControlPay™ Platform is designed to provide transaction processing for a variety of card products and transaction processing applications.

FIG. 3A shows three transaction processing features of the ControlPay™ Platform, which can be applied to various payment card transaction processing needs (“product solutions”). The first transaction processing feature relates to enhanced controls (e.g., per transaction and cumulative spend amounts, merchant and merchant category, validity periods, geographic information and device controls such as ATM only). The platform provides account owners with unprecedented control over the spending that is charged to their accounts. Spending can be controlled in various ways including by value, time period, merchant type and/or geography. The controls can be combined to support specific product initiatives (e.g., Dependent Card, Travel Card, Online Single Use Card). The second transaction processing feature relates to transaction routing. Transaction routing may be established by the issuer, and suitably modified by the cardholder or other entity. The platform allows management of a diverse set of payment devices (e.g., mag-stripe card, RFID, virtual) based on transaction routing rules established by the cardholder and/or issuer to ensure transactions are routed to the appropriate funding account (e.g., credit, debit, home equity, etc.). A third transaction processing feature relates to security and fraud prevention. The platform uses strong authentication methodologies leveraging existing issuer policies to ensure that only authorized users can spend using a specified account. The platform can generate single-use PAN numbers, linked to a base account. These features can be tailored to provide transaction processing for diverse applications (e.g., controlled payment numbers, rewards fulfillment, MasterCard Securecode/Verified by Visa, automatic bill pay, instant credit, supplier payments, PayEverywhere, etc.).

FIG. 3B shows exemplary common platform services, vertical integration of multiple applications, and different access channels provided by exemplary transaction processing platform 210. Implementation of a centralized platform 210 in a payment-by-card network for diverse transaction processing applications can be economically advantageous compared to each entity (e.g., issuer, acquirer, or merchant) establishing and running its own customized transaction processing system.

In an exemplary implementation of the invention, platform 210 is configured to provide intelligent routing of card transactions to bank accounts based on transaction data characteristics and cardholder rules, and/or to provide rules-based authorization controls. Intelligent routing of card transactions to bank accounts based on cardholder rules and transaction data enables “combination card” applications, in which a single card affects different accounts, based on transaction amount, cumulative spend amounts, merchant and merchant category, validity periods, geographic and device controls (e.g., ATM only). Exemplary combinations of different accounts that may be linked to a single payment card include: debit, credit, and secured lending accounts; consumer and business accounts; parent and children accounts; and different general ledger accounts.

Further, the intelligent routing of card transactions to bank accounts enables “diversion” billing to particular accounts in the combination of accounts according to preestablished authorization rules. The authorization rules may be preestablished by either the issuer and/or cardholder. An exemplary authorization rule for a combination of credit, debit and secured lending accounts is as follows:
Purchases under [symbol] 100 go against debit;
Purchases between [symbol] 100 and [symbol] 500 go towards credit; and
Purchases greater than [symbol] 500 go against secured lending or installment account.

Another exemplary authorization rule for a combination of different GL accounts is as follows:
Purchases with Restaurant & Travel Merchant Category Code (MCC) go against a T&E GL account;
Purchases with Stationary MCC go against a supplies GL account; and
Purchases with Supermarket and Retail Clothing MCC go against a private account.

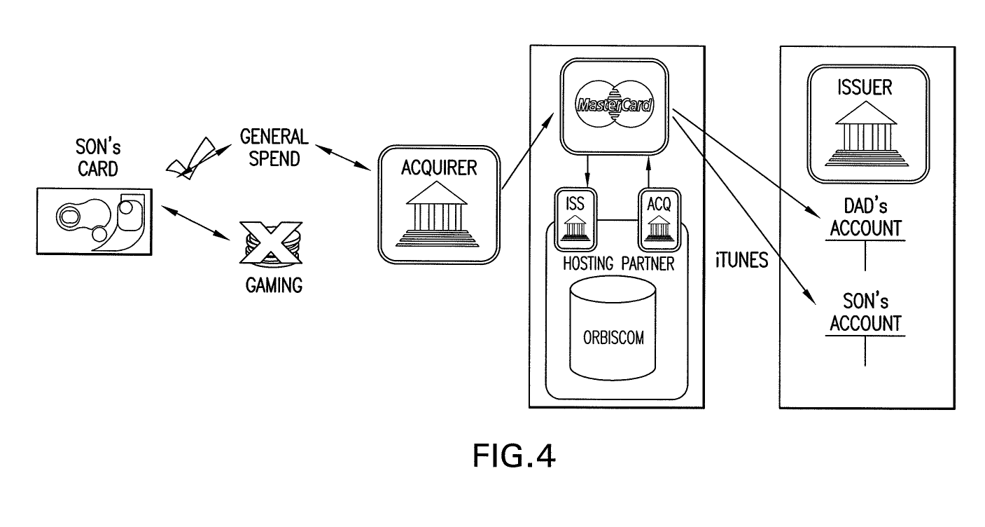

An exemplary authorization rule for a combined parent and children account (See FIG. 4), where a son at college has a card that does not allow, for example, gaming charges, is as follows:
Common charges go to parents' account; and
i-tunes charges go to son's account.

Further, platform 210 may be configured to implement rules-based authorization controls on transactions made by cardholders. The rules for authorization control may be preestablished by either the issuer and/or the cardholder. Exemplary rules for authorization control are as follows:
Exclude gaming;
MCC blocking;
Merchant blocking (fleet);
Limited geographical acceptance; and/or
Curfews.

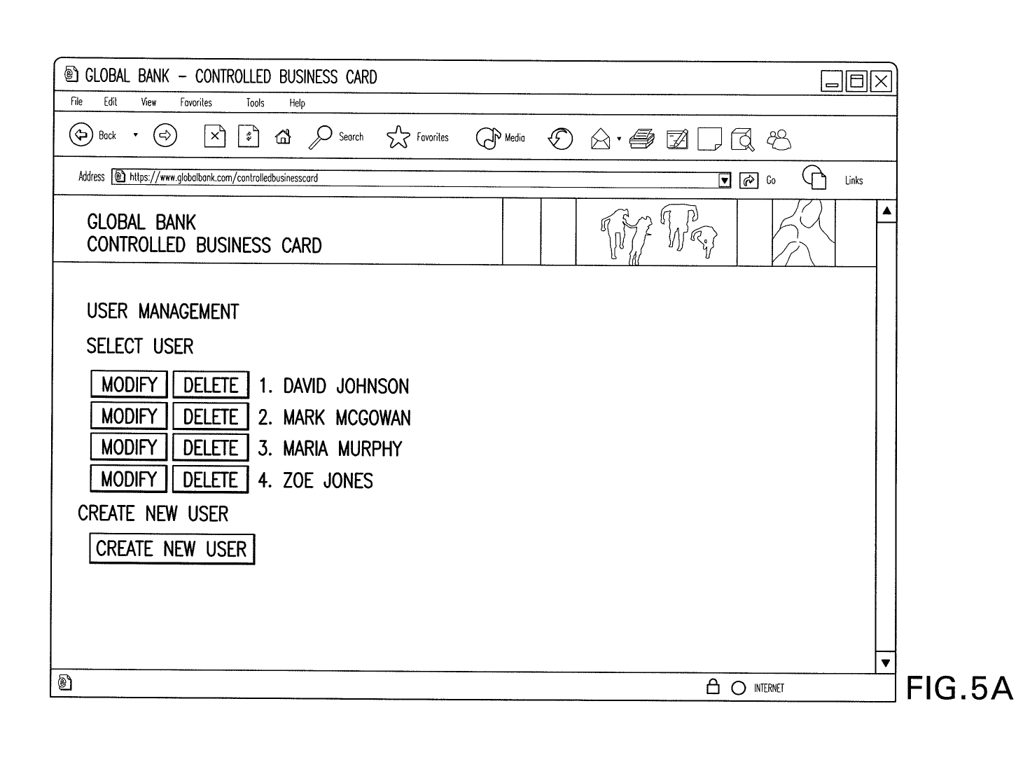

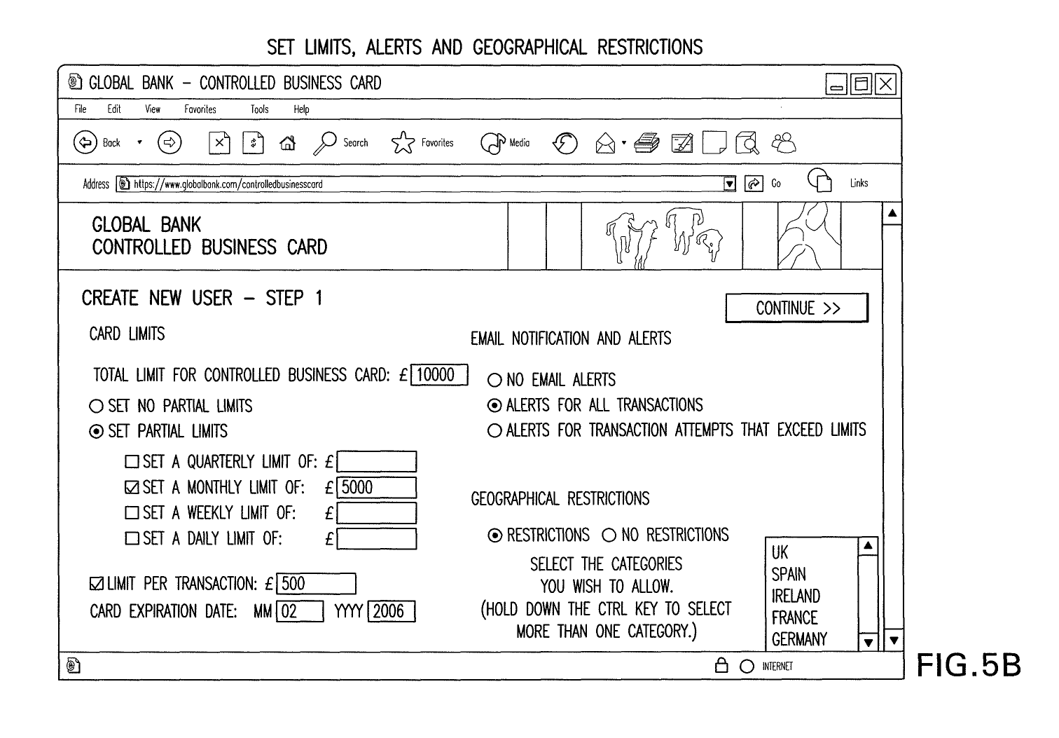

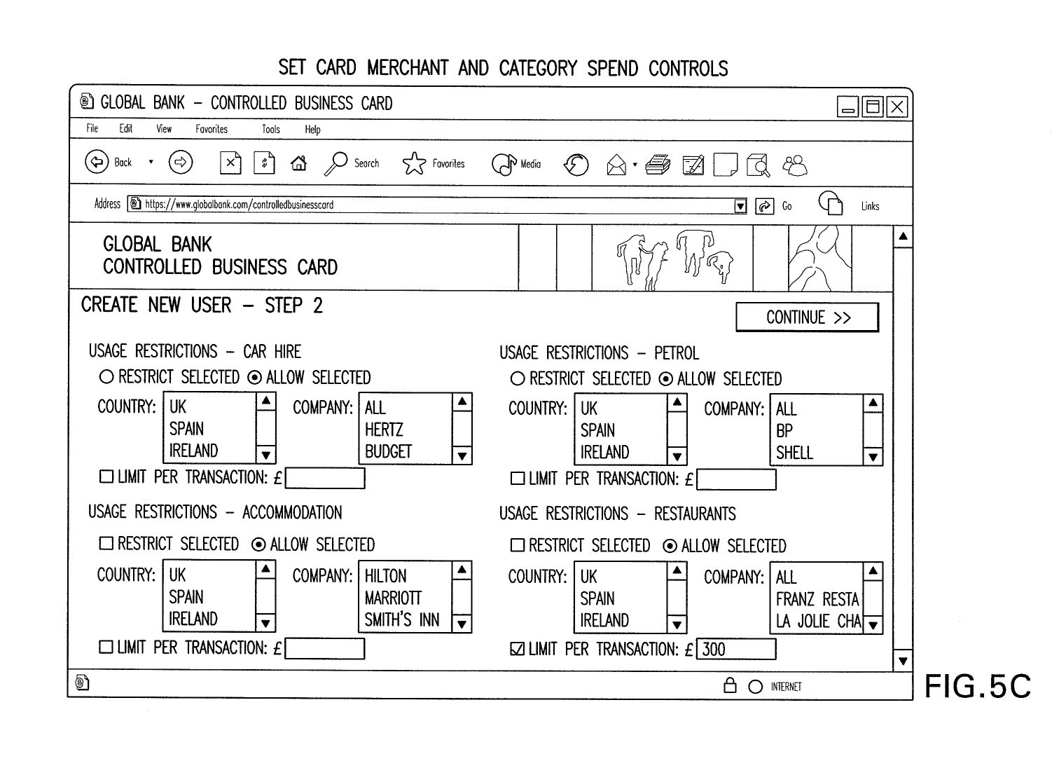

FIGS. 5A-5C show screen shots of exemplary user web interfaces coupled to platform 210. The interfaces can be used to accept user defined authorization control rules. The figures show an example of a global business card, which has multiple employees as authorized users (FIG. 5A). The use of the business card by each employee is subject to amount and place restrictions (e.g., total limit, per transaction limit, geographical limits, FIG. 5B) and card merchant and category spend controls (FIG. 5C).

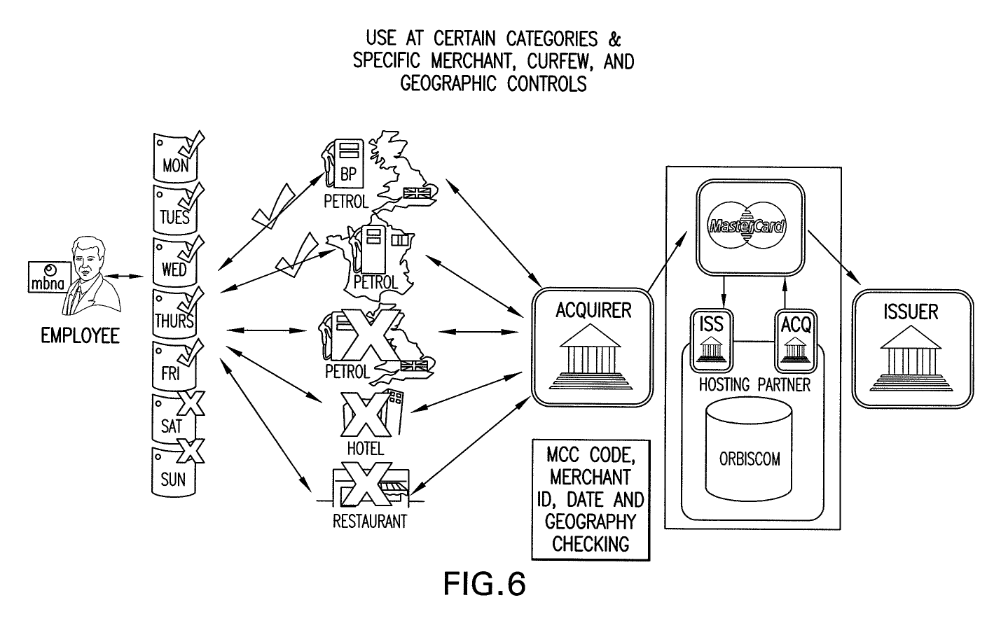

With reference to FIG. 6, platform 210 is configured to interrogate each authorization request for transactions made with the employee business cards to enforce authorization control. As an example of category control, an employee may have a card, which is intended only for use at petrol stations, hotels, and restaurants. Platform 210 may verify the MCC in each such authorization request to confirm that the transaction is in the authorized category (i.e., a petrol station, hotel, or restaurant) before the authorization request is forwarded to the issuer for further processing. If the MCC is not in the authorized category, the authorization request is denied by platform 210.

As a further example of category control, the employee's card may be intended only for use at specific merchants (e.g., British Petroleum petrol stations and Hilton hotels). In this case, platform 210 checks the MCC in each such authorization request to confirm that the transaction is in the authorized category (i.e., a petrol station, hotel, or restaurant), and further checks the Merchant ID in the authorization request to confirm that the transaction is with one of the specifically allowed merchants before forwarding the authorization request to the issuer for further processing. If the MCC is not in the authorized category or the Merchant ID does not correspond to one of the specifically allowed merchants, the authorization request is denied by platform 210.

As yet a further example of category control, the employee's card may be intended for use only at specific times (e.g., only on weekdays). In such case, platform 210 is configured to check the MCC and the Merchant ID, and further to check the date/time of the transaction as a basis for forwarding or denying the authorization request.

As still a further example of category control, the employee's card may be intended for use at any petrol station outside the U.K., but only at specific merchants (e.g., British Petroleum petrol stations) in the U.K. In such case, platform 210 is configured to check the MCC, Merchant ID, and transaction date/time, and to further confirm the country of the transaction as a basis for forwarding or denying the authorization request.

In another implementation of the invention, platform 210 can be configured to provide transaction processing for acceptance of non-ubiquitous payment device types over a standard payment-by-card network (e.g., MasterCard payment network). An exemplary non-ubiquitous payment device is the AirPlus Company Account (UATP) card, which is issued by a few airlines to preferred corporate customers for consolidated payment for flights and travel agency services. Other examples of less well accepted or non-ubiquitous payment device types include private label devices, closed loop payment devices such as PayPal, other payment brands, and new payment device types found in the telecommunications industry. Platform 210 allows ubiquitous acceptance of the less well accepted payment types via the acceptance networks of well accepted payment brands such as MasterCard or Visa. Merchants do not have to change acceptance, back end web design, or sign up to accept the less well accepted payment types. A unique MasterCard/Visa number is generated for every transaction where a closed loop payment device/solution is not accepted and the transaction occurs against the primary account as if the merchant naturally accepted the payment type.

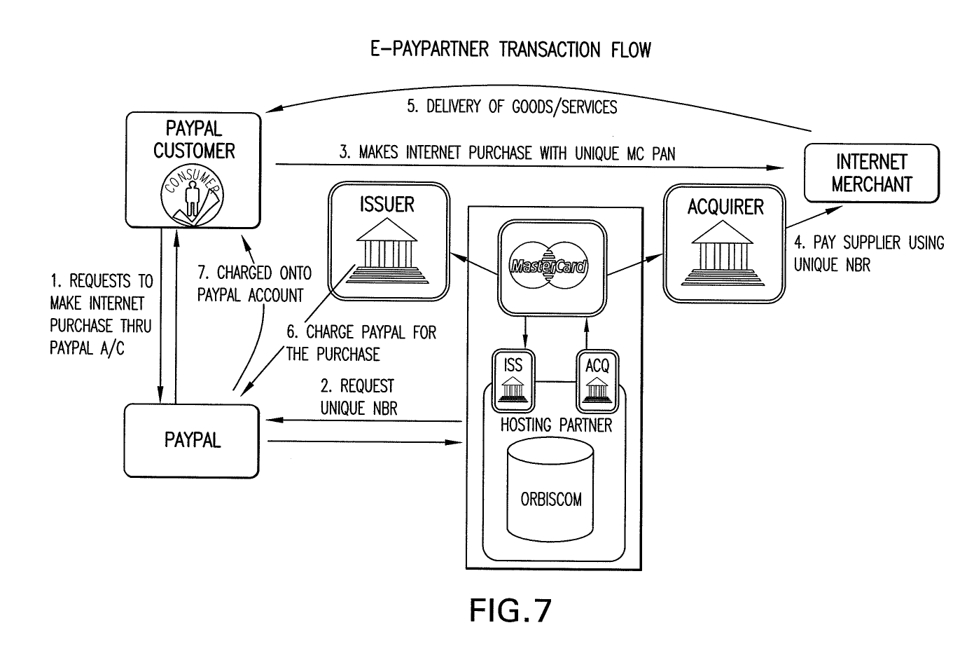

FIG. 7 shows exemplary transaction processing flows via the payment-by-card network for a non-ubiquitous payment device transaction (e.g., PayPal) made, for example, over the Internet. A customer can sign up for a pay anywhere feature on their payment card “Brand A” (e.g., MasterCard). A unique MasterCard number (e.g., MasterCard Number “nbr”) is generated for each transaction when the payment brand is not accepted by the merchant. The transaction for the non-ubiquitous payment device occurs against a primary account with the same acceptance process as if the merchant had accepted a Brand A device. No work is required of the merchants to enable the pay anywhere transaction with a non-ubiquitous payment, which is accepted by the merchant as if the transaction as if a real/MasterCard card was used. The transaction process flows are mediated by platform 210 in manner that does not require the merchant to change acceptance or back end web design, or to sign up to accept the particular non-ubiquitous payment device type. The unique MasterCard Number “nbr” is used for making the transaction flows compatible with the standard branded payment card transaction flows.

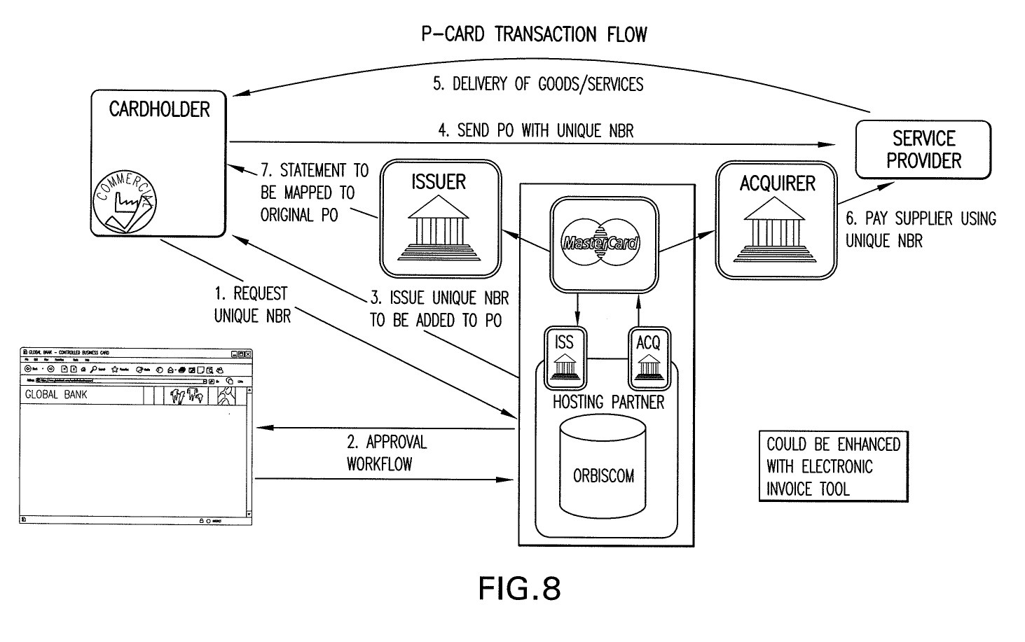

In yet another implementation of the invention, platform 210 can be configured to provide transaction processing for purchasing card (“P-Card”) programs (FIG. 8). P-Cards were originally designed as a payment tool for low-value indirect goods and services—mainly maintenance, repair and operations, and office supplies—requisitioned by employees of a company. Processing the requisitioned transactions through a traditional purchase order process in the company would often cost more than the goods and services themselves. P-Card efficiencies were estimated to result in savings ranging from 55% to 90% of the transactional cost. However, P-Cards are not as widely used as possible by large corporations and government agencies, because of noted difficulties or drawbacks with supplier initiated payment, maverick spend risk, poor corporate governance (e.g., no segregation of duties), minimal pre-purchase controls, fraud concerns, and resource intensive manual reconciliation.

P-Card controls can support company purchasing policy compliance, for example, through Supplier Base Consolidation, Spend Limits by transaction, Spend Limits by Period, and Merchant Category Code Exclusions. Platform 210 can be configured to implement these and/or other P-Card controls. FIG. 8 shows exemplary transaction process flows for P-Card programs. Platform 210 generates a unique number, which is associated with each purchase order made using a P-Card. The unique number allows tracking and processing of the transaction through standard payment networks as if it were a regular card transaction. Platform 210 may be further configured to support electronic invoicing of P-Card purchases.

The centralized implementation of P-Card controls and transaction processing can overcome the drawbacks associated with previous use of P-Cards (e.g., resource intensive manual reconciliation and poor integration with ERP systems), and therefore encourage significantly greater use of P-Cards for business-to-business (B2B) transactions.

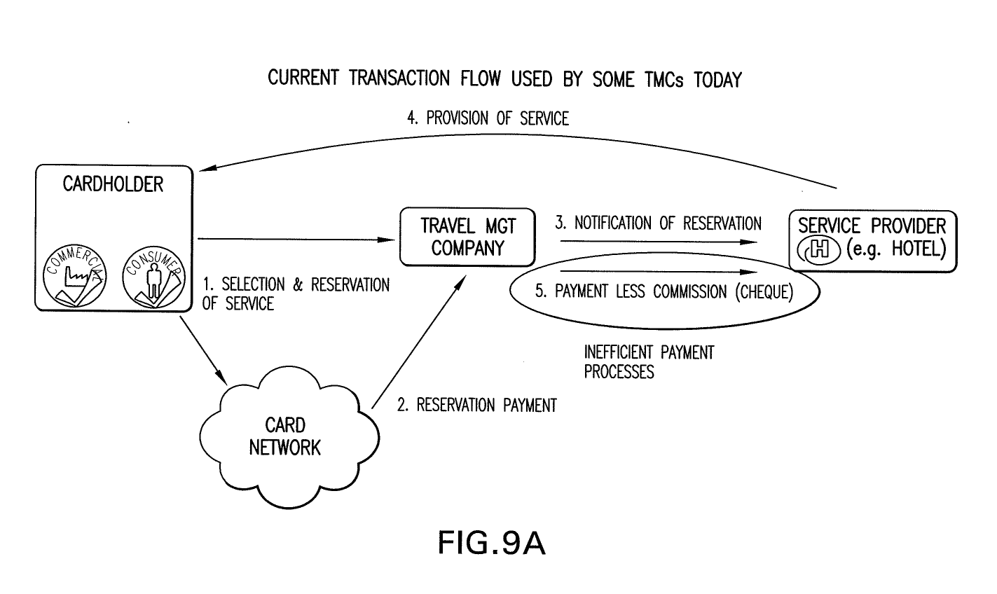

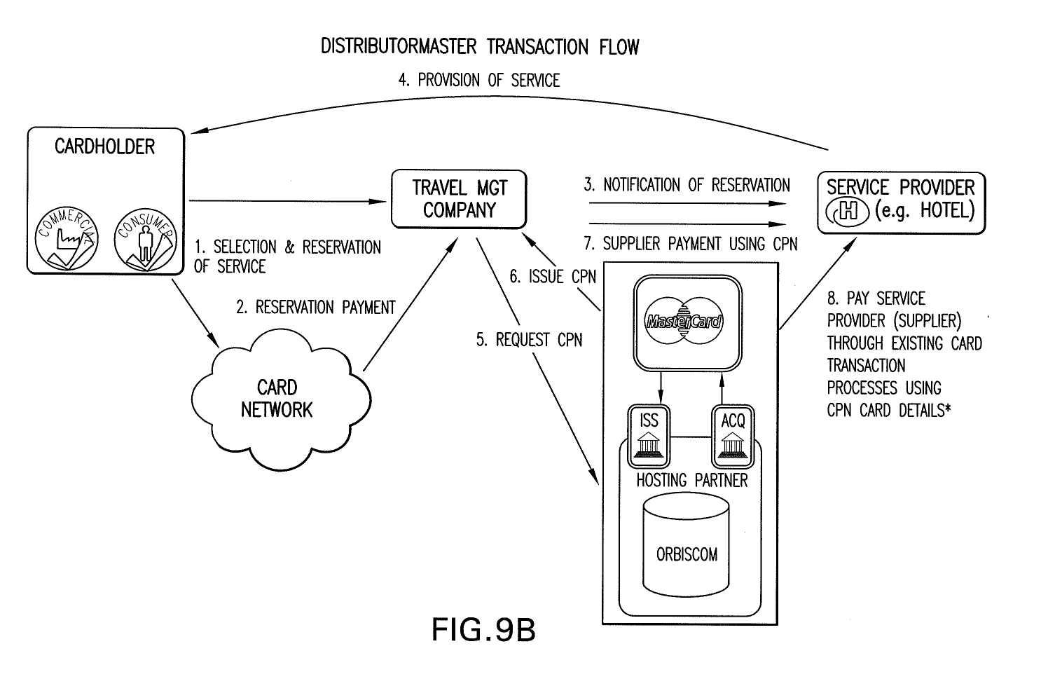

In yet another implementation of the invention, platform 210 can be configured to provide transaction processing for all brokerage type (e.g., Travel Management Company) supplier payments through the standard payment-by-card network (FIGS. 9A and 9B). Such configuration of platform 210 may be directed to service ‘brokers’, i.e., companies distributing/re-selling products for a multitude of diverse suppliers (e.g., travel agencies, insurance companies, and car leasing companies, etc.). This configuration of platform 210 enables brokers to pay diverse suppliers in a controlled way using the card payment acceptance network replacing inefficient, legacy, mostly paper-based payment methods (FIG. 9A).

Platform 210 is configured to maintain approval workflow for every P-Card transaction to ensure segregation of duties and to prevent employee fraud and errors. Once a P-Card purchase, which adheres to corporate purchasing policy is approved, a unique purchase card number—Controlled Payment Number (CPN), is provided for the transaction. Controls (supplier, amount, etc.) are associated with the CPN before the CPN is issued. Not a penny can be charged without approval. The CPN can be used only with the approved vendor, only for the approved amount, and only within a specific time frame. Once the CPN is used, it cannot be used again. Transactions will only pass settlement if they adhere to these controls. Thus, there is no margin for error, fraud or non-compliance. The unique CPN acts as a primary key, allowing each individual transaction to be separately identified. This allows platform 210 to offer reconciliation and data capture functionality for ERP integration.

This method of P-Card transaction processing advantageously results in control before the purchase has occurred.

In further implementations of the invention, platform 210 may be configured to provide security for Internet payment transactions. For these applications, platform 210 is configured to generate a single-use PAN or Controlled Payment Number (CPN). The CPN is requested by a cardholder (e.g., credit or debit cardholder) prior to Internet payment. In the online transactions, the CPN is used as a front or proxy for a cardholder's real card number. The CPN enables the cardholder to shop online at any merchant without having to reveal his or her real card details to the merchant. Nevertheless, the merchants can process the transactions as if they were made with the cardholder's real card number. No merchant adoption required. In practice, a cardholder can request a CPN that will front for his or her real card number from the bank for use in any Card Not Present transaction. Depending on the controls set by the cardholder (or the card issuer), the CPN can be valid for a single transaction or multiple transactions. Transactions made using the CPN are ultimately authorized and settled against the cardholder's real account.

The inventive centralized transaction processing platform is further described herein with reference to its use in conjunction with standard online payment networks (e.g., EPSnet, BankNet and Global Clearing Management System (GCMS)), which are provided to the payment-by-card industry by assignee MasterCard International, Inc. (“MasterCard”). EPSnet is a telecommunications network, which is used in Europe to link issuers and acquirers for Online POS/ATM Transaction Processing. EPSnet interfaces with BankNet, which is a global telecommunications network linking all MasterCard card issuers and data processing centers into a single financial network. GCMS is a centralized payment processing system, which facilitates the processing of payment transactions and information management among the parties. In addition to MasterCard, transaction processing by GCMS involves four participants: issuers (the cardholders' banks), acquirers (the merchants' banks), merchants, and cardholders. GCMS uses MasterCard's IP network to link its member banks to retailers and other merchants. Payment transaction and information management messages may have a standard industry format, for example, the Integrated Product Message (IPM) format, which is a feature-rich, flexible, variable-length format that supports new technologies such as chip cards, e-commerce and member-to-member proprietary data. The IPM formats or other industry standard formats designate particular transaction message types and particular data elements (DE) in those messages for particular transaction information.

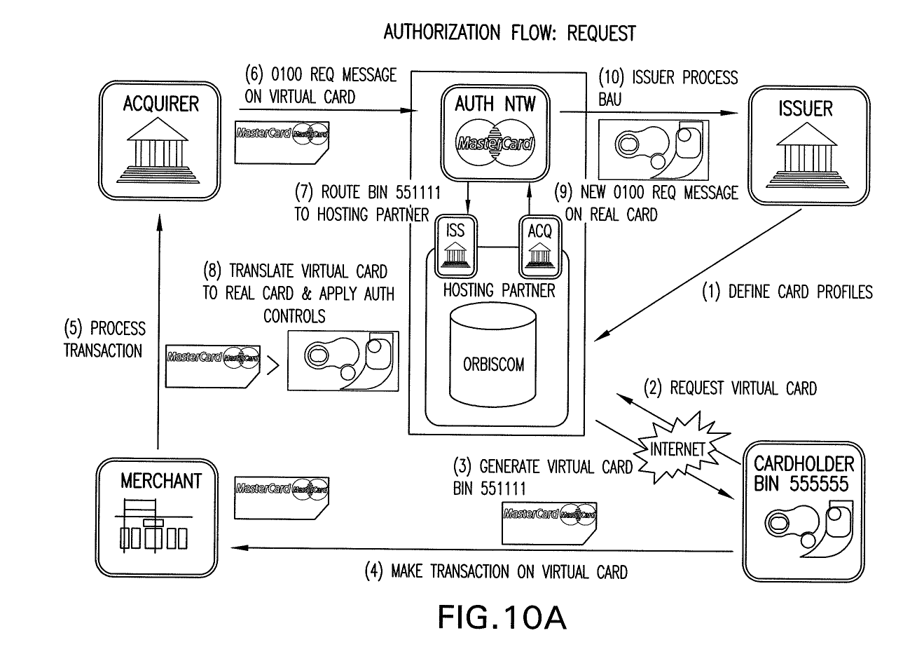

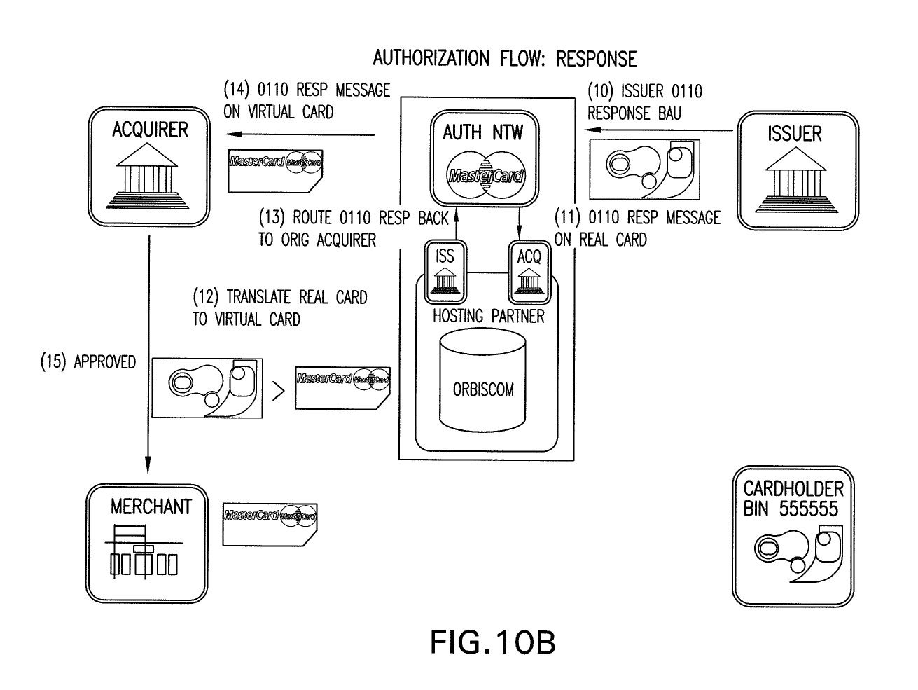

FIGS. 10A, 10B, 11A, 11B and 12 show transaction processing flows through the standard MasterCard payment network mediated by platform 210 that is hosted by a hosting partner. An online transaction conducted by a bank's customer (cardholder) is used as an example in the figures. Platform 210 may be configured to maximize re-use of existing issuer infrastructure.

In payment transaction processing, authorization occurs when a merchant and/or acquirer requests approval for a cardholder's transaction from an issuer. Clearing and settlement refers to processes that determine the amounts due between issuers/banks and acquirers/merchants for payment transactions and associated fees.

FIG. 10A shows exemplary set up and authorization request flows (1)-(10) mediated by platform 210. The transaction flows, which are numbered in the figure, are as follows:
(1) The bank prepares card profiles.
(2) Cardholder logs on to web site and requests virtual card
(3) Platform 210 generates and provides virtual card number (CPN) “BIN 551111” to cardholder
(4) Cardholder makes transaction with Merchant (physical or virtual).
(5) Merchant forwards transaction data to Acquirer.
(6) Acquirer forwards 0100 request message on virtual card to authorization network (e.g. EPSNet).
(7) Authorization network routes virtual card number “BIN 551111” to hosting partner (platform 210).
(8) Platform 210 maps virtual card number “BIN 551111” to real card numbers.
(9) Platform 210 generates new or updates 0100 request message on real card
(10) Issuer Bank processes transaction as Business As Usual (BAU) on real card.

FIG. 10B shows authorization response flows (10)-(15) mediated by platform 210. The transaction flows, which are numbered in the figure, are as follows:
(10) Issuer Bank processes 0110 response message as Business As Usual (BAU).
(11) Authorization network routes 0110 response message on real card to platform 210/hosting partner.
(12) Platform 210 maps the real card number to the virtual card number for routing back to the original Acquirer (13)
(14) Authorization network sends 0110 response message on virtual card number to the original Acquirer, who can then forward authorization (15) to the merchant.

Integration of platform 210 and MasterCard network formats for the authorization request/response process flows shown in FIGS. 10A and 10B require consideration of the following functions:
Update of data fields as the transaction message passes through
   System Trace Audit Number (DE11) unique in 2 flows
   Update of virtual card into real card PAN (DE002) and vice versa
   Store and Update Acquirer fields (DE032-DE033).

Further, the virtual card number CPN may be provided in an authorization message in DE124 or obtained through Customer Support System (CSS)}.

Additionally, integration of platform 210 with the bank processes and formats for the authorization request/response process flows shown in FIGS. 10A and 10B require consideration of the following functions: batch upload of card profiles to CPN platform, batch upload of replacement cards, and support for CPN in proprietary field DE124 of authorization message or CSS service.

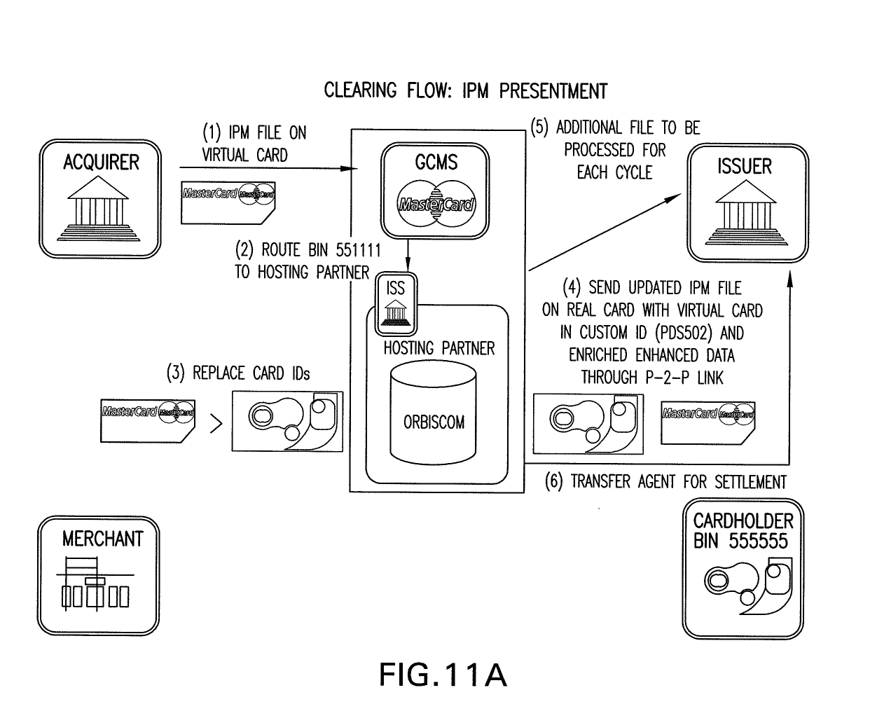

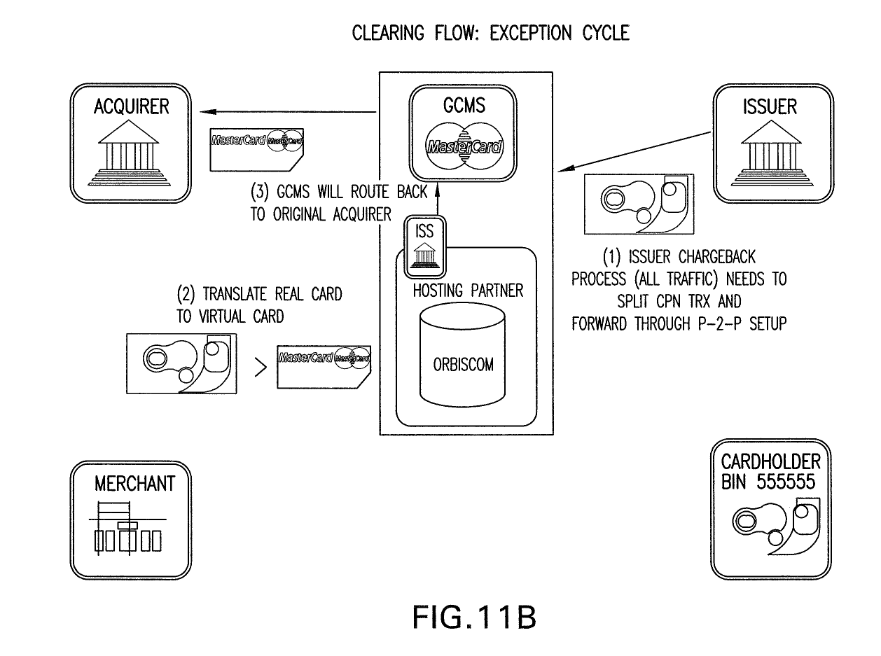

FIG. 11A shows exemplary clearing presentment flows (1)-(6) through MasterCard's′ GCMS network mediated by platform 210. The transaction flows, which are numbered in the figure, are as follows:
(1) The Acquirer sends an IPM file on virtual card “BIN 551111” to GCMS.
(2) GCMS forwards the “BIN 551111” IPM message to platform 210/hosting partner.
(3) Platform 210 updates the IPM file with the real card number corresponding to virtual card number (CPN) “BIN 551111”.
(4) Platform 210 forwards the updated IPM file on the real card number for additional processing at the Issuer Bank. Platform 210 may include CPN information in the Custom ID (PDS502) using a P2P interface.
(5) The additional file is processed at the Issuer Bank.
(6) Transfer Agent flows for settlement of P2P traffic.

Integration of platform 210 and MasterCard network processes and formats for the IPM presentment flows shown in FIGS. 11A and 11B require consideration of the following functions:
Update of virtual card into real card PAN (DE02) keeping CPN in Custom ID (PDS502);
Keeping interchange fields (PDS146), reconciliation and administrative messages;
Enrichment of clearing messages with enhanced data captured on platform 210
Setup of new P2P link from hosting partner to Issuer Bank and
   Setup of transfer agent whereby the bank will settle the GCMS flow directly (settlement will reflect exactly what is in the P2P file).

Further, integration of platform 210 and bank processes and formats for the IPM presentment flows shown in FIGS. 11A and 11B require consideration of the following functions:
Pick up of one additional clearing file during each cycle. The format of the additional clearing file is exactly the same as that of conventional IPM files and will be received as if processed by MasterCard.
Custom ID (PDS502) for mapping to Issuer Bank corporate card reporting system (CDF).
Settlement integrated in existing process.

FIG. 11B shows exemplary clearing exception cycle flows (1)-(3) mediated by platform 210. The transaction flows, which are numbered in the figure, are as follows:
(1) Issuer chargeback process (all traffic) is split CPN trx (based on BIN) and forwarded through the P-2-P setup to platform 210/hosting partner.
(2) Platform 210/hosting partner translates real card and virtual card number information.
(3) GCMS routes chargeback message to the original Acquirer.

Integration of platform 210, MasterCard, and bank processes and formats for the clearing exception cycle flows require consideration of the following factors:
Update of real card into Virtual PAN (DE002) and forward on to GCMS.
Settlement will go immediately to the bank through the Transfer Agent and be integrated in reconciliation of non-CPN traffic.
After a chargeback batch has run on the Issuer Bank, a separate script needs to isolate transactions on CPN BIN and split in a second file to be sent over the P2P link.

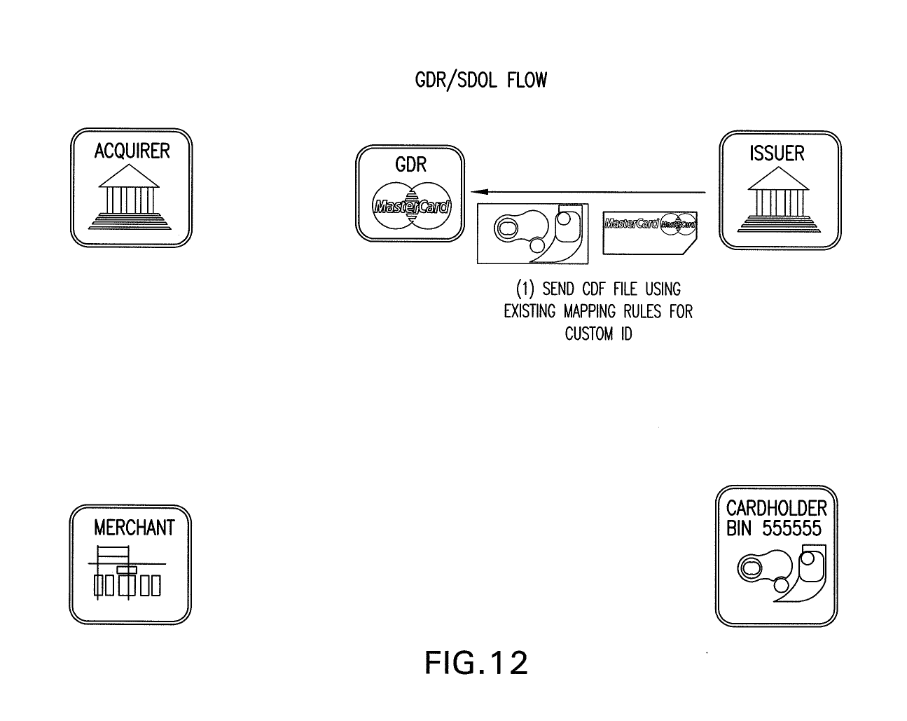

FIG. 12 shows a GDR/SDOL (Smart Data On Line) flow which is used to set up the relationship between the bank and MasterCard (e.g., for corporate card reporting). For this the Issuer Bank sends a CDF file to MasterCard using mapping rules for Custom ID.

Integration of platform 210, MasterCard, and bank processes and formats for the GDR/SDOL flow shown in FIG. 12 requires enhanced data matching on the CPN in Custom ID.

It will be understood that the foregoing is only illustrative of the principles of the disclosed subject matter, and that various modifications can be made by those skilled in the art without departing from the scope and spirit of the disclosed subject matter as defined by the appended claims. Exemplary embodiments may be combined with other exemplary embodiments or modified to create new embodiments.

What is claimed:

1. A system for processing payment transactions for cardholders, wherein the transactions are initiated using one of a plurality of diverse payment devices including conventional “plastic” magnetic stripe or smart payment cards and unconventional payment devices, the system comprising:
a centralized transaction processing platform connected to a standard payment-by-card industry network that processes transactions made with conventional payment cards,
wherein the centralized transaction processing platform is configured to interrogate payment transactions initiated using any one of the plurality of diverse payment devices, apply pre-defined transaction controls, and to accordingly deny transaction authorization requests or forward the same on the network to payment card issuers for further processing.

2. The system of claim 1 wherein the centralized transaction processing platform is a partner hosted platform.

3. The system of claim 1 wherein the centralized transaction processing platform is configured to support a web interface for cardholder access.

4. The system of claim 1 wherein the centralized transaction processing platform is configured to apply rules-based transaction controls.

5. The system of claim 1 wherein the centralized transaction processing platform is configured to apply the rules-based transaction controls before the transaction is made.

6. The system of claim 1 wherein the centralized transaction processing platform is configured to route transactions according to pre-determined routing rules for the funding the payment transactions.

7. The system of claim 1 wherein the centralized transaction processing platform is configured to generate a controlled payment number (CPN) that serves as a proxy for the cardholder's real card or account number in transaction processing.

8. The system of claim 6 wherein the centralized transaction processing platform is configured to provide a CPN to the cardholder upon request for use in Card Not Present transactions as a proxy for the cardholder's real card or account number.

9. The system of claim 1 wherein the centralized transaction processing platform is linked to an issuer via a P2P link via the payment network's infrastructure, and is further configured to communicate transaction settlement flows over the P2P link.

10. The system of claim 9 wherein transaction chargebacks are routed from the issuer to the centralized transaction processing platform via the P2P link.

11. A method for processing payment transactions for cardholders, wherein the transactions are made using one of a plurality of diverse payment devices including conventional “plastic” magnetic stripe or smart payment cards and unconventional payment devices, the method comprising:
connecting a centralized transaction processing platform to a standard payment-by-card industry network that processes transactions made with conventional payment cards,
at the centralized transaction processing platform, interrogating payment transactions;
applying pre-defined transaction controls; and
accordingly, denying transaction authorization requests or forwarding the same on the network to payment card issuers for further processing.

12. The method of claim 11 wherein the centralized transaction processing platform is a partner hosted platform.

13. The method of claim 11 further comprising configuring the centralized transaction processing platform to support a web interface for cardholder access.

14. The method of claim 11 further comprising, at the centralized transaction processing platform, applying rules-based transaction controls.

15. The method of claim 11 further comprising at the centralized transaction processing platform, applying the rules-based transaction controls before a purchase is made.

16. The method of claim 11 further comprising, at the centralized transaction processing platform, routing transactions according to pre-determined routing rules for the funding the payment transactions.

17. The method of claim 11 further comprising, at the centralized transaction processing platform, generating a controlled payment number (CPN) that serves as a proxy for the cardholder's real card or account number in transaction processing.

18. The method of claim 16 further comprising, at the centralized transaction processing platform, providing a CPN to the cardholder upon request for use in Card Not Present transactions as a proxy for the cardholder's real card or account number.

19. The method of claim 11 further comprising communicating transaction settlement flows between the centralized transaction processing platform and an issuer over a P2P link.

20. The method of claim 19 further comprising routing chargebacks from the issuer to the centralized transaction processing platform via the P2P link.
